(19) United States
(12) Patent Application Publication
(10) Pub. No.: US 2026/0087268 A1
(43) Pub. Date: Mar. 26, 2026

(54) SYSTEM FOR DYNAMIC CONTENT CORRECTION THROUGH ADAPTIVE AUTO-PROMPTING AND METHOD THEREOF

(71) Applicant: L&T TECHNOLOGY SERVICES LIMITED, Chennai (IN)

(72) Inventors: NIVEDITHA SURESHBABU, Bengaluru (IN); AVANTHIKA RAGUNATHAN, Coimbatore (IN); KAVIPRIYA BALASANKAR, Cuddalore (IN); RAJESH RAJ, Bengaluru (IN); MADHUSUDAN SINGH, Bangalore (IN)

(21) Appl. No.: 19/307,167

(22) Filed: Aug. 22, 2025

(30) Foreign Application Priority Data
Sep. 23, 2024 (IN) 202441071929

(51) Int. Cl. G06F 40/40; G06N 3/042

(52) U.S. Cl. CPC G06F 40/40; G06N 3/042

(57) ABSTRACT

The present disclosure provides system for dynamic content correction through adaptive auto-prompting. System includes one or more processors and memory. One or more processors are configured to: determine context of content by analysing user input using knowledge ingestion agent; generate one or more prompts based on context using prompt creation agent; create initial content based on one or more prompts; modify one or more subsequent prompts based on one or more parameters; rank each of one or more subsequent prompts using prompt ranking and selection agent based on at least one of relevance, user feedback, and predefined criteria; provide selected set of one or more subsequent prompts to user based on rank of each of one or more subsequent prompts; and dynamically generate refined content for selected set of one or more subsequent prompts based on one or more parameters.

### TECHNICAL FIELD

The present disclosure relates to artificial intelligence (AI) systems and, more specifically, to a multiagent based system for dynamic content correction and alignment using auto-prompting.

### BACKGROUND

Artificial intelligence (AI) systems have become increasingly integral in various domains, particularly in information retrieval and personalized assistance. These systems are designed to enhance user interactions by providing relevant and tailored responses. However, many existing AI models are constrained by static and inflexible input prompts. Such prompts often fail to adapt to evolving user preferences, leading to responses that are either irrelevant or unsatisfactory, thereby undermining user trust and engagement.

Current AI models frequently produce generic outputs that lack personalization, resulting in interactions that do not resonate with individual users. This lack of customization diminishes the effectiveness of these systems and exacerbates user dissatisfaction. The central challenge lies in developing a collaborative AI system that enables the co-design of input prompts in alignment with the specific preferences and expectations of end-users. The premise is that achieving accurate and relevant responses necessitates the formulation of appropriate and dynamic prompts tailored to individual needs.

Moreover, the effectiveness of AI systems is heavily dependent on the quality of prompts used during interactions. Traditional model training methodologies are troubled with inefficiencies, including extensive computational requirements and prolonged training durations. These inefficiencies are particularly pronounced in reinforcement learning scenarios, where the iterative process of refining prompts can be resource intensive.

The present disclosure is directed to overcome the limitations stated above or any other limitations associated with the prior art.

The information disclosed in this background of the disclosure section is for enhancement of understanding of the general background of the invention and should not be taken as an acknowledgement or any form of suggestion that this information forms the prior art already known to a person skilled in the art.

### SUMMARY

Embodiments of the present disclosure address the above-stated problems by providing a multiagent system that dynamically corrects and refines content based on user feedback or, in the absence of feedback, through automated evaluation. By utilizing a multi-agent framework, the multiagent system continuously adapts, improving the relevance and quality of generated content in real time.

The foregoing summary is illustrative only and is not intended to be in any way limiting. In addition to the illustrative aspects, embodiments, and features described above, further aspects, embodiments, and features will become apparent by reference to the drawings and the following detailed description.

Certain aspects of the present disclosure provide a system for dynamic content correction through adaptive auto-prompting. The system may include one or more processors and a memory. The one or more processors are configured to: determine a context of a content by analysing user input using a knowledge ingestion agent; generate one or more prompts based on the context using a prompt creation agent; create an initial content based on the one or more prompts; modify one or more subsequent prompts based on one or more parameters; rank each of the one or more subsequent prompts using a prompt ranking and selection agent based on at least one of relevance, user feedback, and predefined criteria; provide a selected set of the one or more subsequent prompts to user based on the rank of each of the one or more subsequent prompts; and dynamically generate a refined content for the selected set of the one or more subsequent prompts based on the one or more parameters.

In an embodiment of the present disclosure, the one or more parameters include at least one of user feedback to the one or more subsequent prompts or evaluating the one or more subsequent prompts using a pretrained large language model (LLM).

In an embodiment of the present disclosure, the one or more processors are configured to update a knowledge base with the refined content using a knowledge creation agent. The knowledge base is used in subsequent prompt generation and content correction.

In an embodiment of the present disclosure, the knowledge ingestion agent is configured to continuously monitor the user input for updates and automatically extract new context upon determining the updates.

In an embodiment of the present disclosure, the one or more processors are configured to analyze patterns in the user feedback received to refine the subsequent prompts to align with anticipated user preferences.

In an embodiment of the present disclosure, the prompt ranking and selection agent is configured to select contextually appropriate prompts based on the user preferences and the context of the query.

In an embodiment of the present disclosure, the one or more processors are configured to store the one or more prompts, the one or more subsequent prompts and associated user feedback in a prompt store.

Another exemplary aspect of the disclosure provides a method for dynamic content correction through adaptive auto-prompting. The method may include: determining a context of a content by analysing user input using a knowledge ingestion agent; generating one or more prompts based on the determined context using a prompt creation agent; creating an initial content based on the one or more generated prompts; modifying one or more subsequent prompts based on one or more parameters; ranking each of the one or more subsequent prompts using a prompt ranking and selection agent based on at least one of relevance, user feedback, and predefined criteria; providing a selected set of the one or more subsequent prompts to user based on the rank of each of the one or more subsequent prompts; and dynamically generating a refined content for the selected set of the one or more subsequent prompts based on the one or more parameters.

It is to be understood that the aspects and embodiments of the disclosure described above may be used in any combination with each other. Several of the aspects and embodiments may be combined to form a further embodiment of the disclosure.

The above summary is provided merely for the purpose of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### OBJECTS OF THE INVENTION

The main object of the present disclosure is to enable Artificial Agent (AI) systems to dynamically adapt and refine generated content in real-time. By incorporating user feedback or automated evaluations, the system ensures that the content remains relevant and personalized, addressing the limitations of static prompt-based systems.

Another object of the present disclosure is to improve the personalization of AI-generated content by co-scheming prompts with users. This system adapts content based on individual preferences, enhancing user satisfaction and engagement across applications such as customer service, content creation, and educational platforms.

Another object of the present invention is to reduce the computational overhead associated with traditional reinforcement learning methods. By utilizing a multi-agent framework, the system optimizes content refinement and adapts to various domains, providing a scalable solution that can be easily deployed in different industries with minimal resource demand.

### BRIEF DESCRIPTION OF THE ACCOMPANYING DRAWINGS

The accompanying drawings, which are incorporated in and constitute a part of this disclosure, illustrate exemplary embodiments and together with the description, serve to explain the disclosed principles. The same numbers are used throughout the figures to reference like features and components. Some embodiments of system and/or methods in accordance with embodiments of the present subject matter are now described below, by way of example only, and with reference to the accompanying figures.

FIG. 1 illustrates a system for dynamic content correction through adaptive auto-prompting, in accordance with various embodiments of the present disclosure.

FIG. 2 illustrates an architecture of the system as shown in FIG. 1, in accordance with some embodiments of the present disclosure.

FIG. 3 is a flowchart of a method for dynamic content correction through adaptive auto-prompting, in accordance with an embodiment of the present disclosure.

It should be appreciated by those skilled in the art that any block diagrams herein represent conceptual views of illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments. The terms “system” and “symmetric autoencoder-based seismic void detection system” may invariably refer to the same system (100) all over this document. The term “subsurface void” can also be referred as “void” all over this document.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of embodiments of the disclosure, reference is made to the accompanying drawings which illustrates specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

In the evolving landscape of conversational Artificial Intelligence (AI), embodiments of the present disclosure address challenges associated static prompting methods often fall short in delivering relevant and satisfying user experiences.

To address this limitation, the present disclosure provides a multiagent system that dynamically corrects and refines content based on user feedback or, in the absence of feedback, through automated evaluation. By utilizing a multi-agent framework, the multiagent system continuously adapts, improving the relevance and quality of generated content in real time.

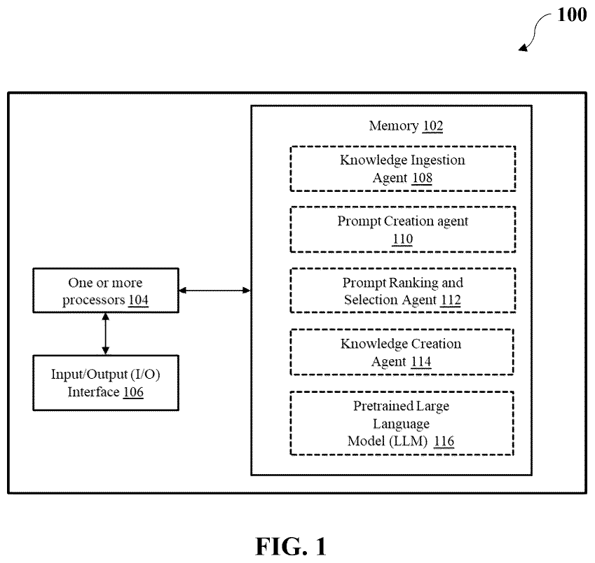

FIG. 1 illustrates a system 100 for dynamic content correction through adaptive auto-prompting, in accordance with various embodiments of the present disclosure. Referring to FIG. 1, the system 100 may include an Input/Output (I/O) interface 102, a memory 104, and one or more processors 106. The memory 104 may include various agents such as a knowledge ingestion agent 108, a prompt creation agent 110, a prompt ranking and selection agent 112, a knowledge creation agent 114, and the like. Further, the memory 104 may also include a pre-trained large language model (LLM) 116.

The Input/Output (I/O) Interface 102 may include suitable logic, circuitry, and interfaces that may be configured to receive a user input (such as, document, voice message, text message, video data, image data, or the like) from a user and provide an output (such as refined data) based on the received user data. The user input may include a content along with a user query. The I/O interface 102 may be coupled with various input and output devices, may be configured to communicate with the one or more processors 106. The I/O device (not shown) such as a display may render inputs and/or outputs of the system 100. Examples of the I/O device may include, but are not limited to, a touch screen, a display device, a keyboard, a mouse, a joystick, a microphone, or a speaker.

Further, the memory 104 may be communicatively coupled to the one or more processors 106 and may comprise various types of data/information and instructions. The data/information stored in the memory 104 may comprise cached data, training dataset(s), validation/testing dataset(s), real-time inferencing data, information regarding a plurality of training techniques, trained AI models, log data of the AI models, but not limited thereto. The memory 104 may include a Random-Access Memory (RAM) unit and/or a non-volatile memory unit such as a Read Only Memory (ROM), optical disc drive, magnetic disc drive, flash memory, Electrically Erasable Read Only Memory (EEPROM), a memory space on a server or cloud and so forth. The one or more processors 106 may be configured to execute the instructions stored in the memory 104 for implementation of the proposed techniques.

The one or more processors 106 may include, but not restricted to, microprocessors, microcomputers, micro-controllers, central processing units, state machines, logic circuitries, and/or any devices that manipulate signals based on operational instructions. The one or more processors 106 may also be implemented as a combination of computing devices, e.g., a combination of a plurality of microprocessors or any other such configuration.

Referring to FIG. 1, the one or more processors 106 may receive the user input from the user via the I/O interface 102. Particularly, the user input may be in the form of a document, a content, an audio, a video, GIFs, but not limited therein. The one or more processors 106 may determine a context of the content by analysing the user input using the knowledge ingestion agent 108. The knowledge ingestion agent 108 may function as an assessment tool for identifying additional knowledge requirements relevant to the user query.

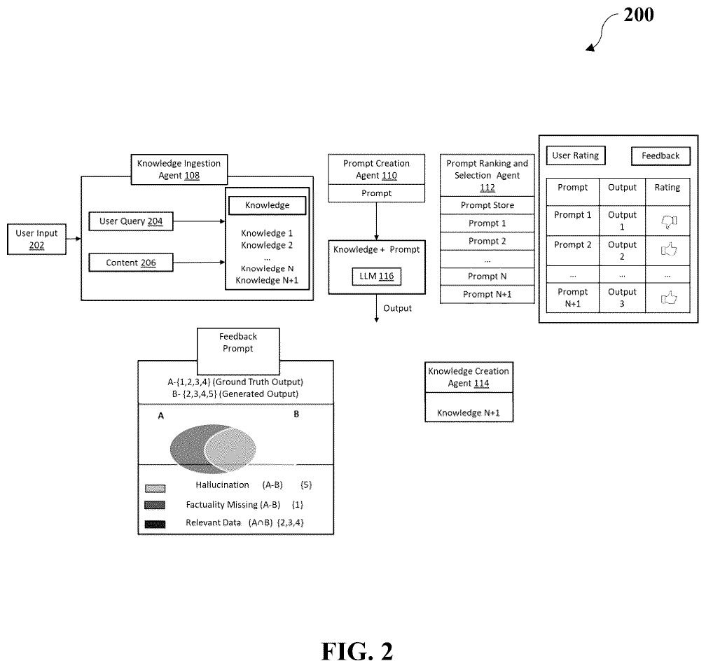

The one or more processors 106 may generate one or more prompts based on the context using the prompt creation agent 110. Initially, a prompt amongst the one or more prompts is selected from a prompt store (shown in FIG. 2), after which an output generation agent (not shown) generates the context associated with that prompt.

Based on the one or more prompts, the one or more processors 106 may create an initial content. Further, the one or more processors 106 may modify one or more subsequent prompts based on one or more parameters. In an embodiment of the present disclosure, the one or more parameters may include at least one of user feedback to the one or more subsequent prompts or evaluating the one or more subsequent prompts using the pretrained large language model (LLM) 116. Furthermore, the one or more processors 106 may rank each of the one or more subsequent prompts using the prompt ranking and selection agent 112 based on at least one of relevance, user feedback, and predefined criteria such as relevance, coherence, grammatical correctness, and overall appropriateness to the prompt.

Moreover, the one or more processors 106 may provide a selected set of the one or more subsequent prompts to the user based on the rank of each of the one or more subsequent prompts. Moreover, the one or more processors 106 may dynamically generate a refined content for the selected set of the one or more subsequent prompts based on the one or more parameters. The one or more processors 106 are configured to update a knowledge base with the refined content using the knowledge creation agent 114. The knowledge base is used in subsequent prompt generation and content correction. The one or more processors 106 are configured to analyze patterns in the user feedback received to refine the subsequent prompts to align with anticipated user preferences. The one or more processors 106 are configured to store the one or more prompts, the one or more subsequent prompts and associated user feedback in a prompt store.

In an embodiment of the present disclosure, the knowledge ingestion agent 108 is configured to continuously monitor the user input for updates and automatically extract new context upon determining the updates. In an embodiment of the present disclosure, the prompt ranking and selection agent 112 is configured to select contextually appropriate prompts based on the user preferences and the context of the query

In an exemplary embodiment of the present disclosure, the Large Language Model (LLM) 116 may be used in automated evaluation of the content when user feedback is not available. The LLM 116 may be trained using a structured process that involves large datasets, fine-tuning, and continuous improvement to ensure that it may effectively assess the quality, relevance, and clarity of generated content.

### Pre-Training of the LLM

In non-limiting embodiment of the present disclosure, the LLM 116 may be first pre-trained on large, diverse datasets that include text from various domains such as literature, technical documents, websites, and other forms of natural language content. The pre-training of the LLM phase focuses on learning general structure of language, grammar, and contextual relationships between words and phrases. During pre-training, the LLM 116 may be exposed to substantial amounts of unlabelled data, allowing the LLM 116 to understand language at a fundamental level. The LLM 116 may be trained to predict the next word in a sentence based on the preceding words, learning the likelihood of word sequences. The LLM 116 may learn to handle complex language structures, identifying context, and distinguishing between different meanings of same word depending on its usage in various scenarios. After the initial pre-training, the LLM 116 may undergoes a fine-tuning process using domain-specific data relevant to the system's applications. For example, if the system is intended for customer service, the LLM 116 is fine-tuned on customer service interactions, troubleshooting dialogues, and support documentation. The fine-tuning process may involve supervised learning where the LLM 116 may be exposed to pairs of input prompts and expected outputs (such as correct responses or high-quality content). As a result, the LLM 116 may learn specific patterns and improve ability of the LLM 116 to evaluate content in the target domain. In one exemplary embodiment of the present disclosure, the fine-tuning process may include supervised learning with labelled data where LLM 116 may trained on specific tasks by exposing it to labelled datasets where each prompt is associated with an ideal response. In another exemplary embodiment of the present disclosure, the LLM 116 may adjusted to handle content evaluation based on the predefined criteria, such as accuracy, clarity, coherence, and relevance, depending on the application. In yet another exemplary embodiment of the present disclosure, the LLM 116 may be fine-tuned based on user-provided feedback, thereby improving its ability to assess content quality and relevance in accordance with user evaluations. Once trained and fine-tuned, the LLM 116 may integrated into the system 100 as an automated evaluator to assess the quality of generated content when user feedback is unavailable. For example, the LLM 116 may evaluate content based on predefined metrics such as relevance, coherence, grammatical correctness, and overall appropriateness to the prompt. The LLM's evaluation process includes comparing the generated content with the initial prompt to determine if the content adequately addresses the query or task. Additionally, the LLM 116 may check for grammar, fluency, and readability to ensure the content meets quality standards. Subsequently, the LLM 116 may assign a score or rank to the generated content based on the predefined criteria. The score is used by the one or more processors 106 to select or refine prompts in subsequent iterations.

FIG. 2 illustrates an architecture 200 of the system 100 as shown in FIG. 1, in accordance with some embodiments of the present disclosure. FIG. 2 is explained in conjunction with FIG. 1. Referring to FIG. 2, the architecture 200 may consists of several key components such as the knowledge ingestion agent 108, the prompt creation agent 110, the prompt ranking and selection agent 112, the knowledge creation agent 114, the LLM 116, but not limited thereto. The architecture 200 outlines a structured process for dynamic content correction using a multi-agent system (also referred to as system 100 of FIG. 1).

As explained in earlier embodiments, the user may provide a user input 202 to the knowledge ingestion agent 108 of the system 100. Referring to FIG. 2, the knowledge ingestion agent 108 may extract the context (i.e., relevant information) from the content 206 and the user query 204 provided as the user input 202. By way of example with no limitation, in a customer service application, if the user asks a question about a specific product feature, the knowledge ingestion agent 108 may retrieve relevant product information from knowledge base of the system 100.

After the necessary knowledge has been ingested, the prompt creation agent 110 may generate a new prompt based on the context provided by the knowledge ingestion agent 108. Based on the new prompt, the initial content may be produced as the output generation agent (now shown). For instance, if the user's query is related to troubleshooting a software issue, the prompt creation agent 110 may generate a prompt focused on guiding the user through possible solutions.

The output generation agent may use both the prompt and the ingested knowledge to produce an output. The generated content may vary depending on the context, for example, a response to a customer inquiry or a technical document. At this point, the user is presented with the generated content and may provide feedback on its accuracy or relevance.

If the user provides feedback, the system 100 may utilize a feedback prompt creation agent which may adjust the initial prompt based on the feedback provided by the user. The modified prompt is then stored in the prompt store which may hold all previously generated prompts for future use. Further, the prompt ranking and selection agent 112 may evaluates the stored prompts, ranking them based on their relevance to the feedback and the predefined criteria. The prompt ranking and selection agent 112 may select a highest-ranked prompt for next iteration of content generation, ensuring that the content better addresses the user's feedback.

When no user feedback is provided, the prompt ranking and selection agent 112 may select next most relevant prompt from the prompt store without any direct user input, using the LLM 116. Particularly, the system 100 may utilize an LLM evaluator to assess the quality and relevance of the generated content in the absence of user feedback.

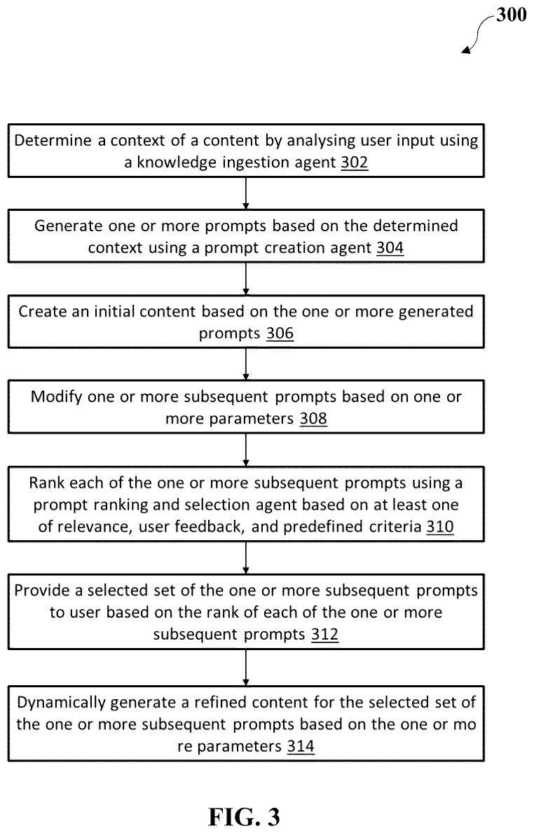

FIG. 3 depicts a flowchart 300 of a method for dynamic content correction through adaptive auto-prompting, in accordance with an embodiment of the present disclosure, in accordance with an embodiment of the present disclosure. FIG. 3 is described in conjunction with reference from FIGS. 1-2. The method illustrated in the flowchart may start from step 302.

At step 302, the context of the content may be determined by analysing the user input using the knowledge ingestion agent 108. At step 304, the one or more prompts are generated based on the determined context using the prompt creation agent 110. At step 306, the initial content is created based on the one or more generated prompts. At step 308, the one or more subsequent prompts are modified based on the one or more parameters.

At step 310, each of the one or more subsequent prompts are ranked using the prompt ranking and selection agent 112 based on the at least one of relevance, user feedback, and the predefined criteria. At step 312, the selected set of the one or more subsequent prompts are provided to the user based on the rank of each of the one or more subsequent prompts. At step 314, the refined content is dynamically generated for the selected set of the one or more subsequent prompts based on the one or more parameters. The one or more parameters includes at least one of the user feedback to the one or more subsequent prompts or evaluating the one or more subsequent prompts using the pretrained large language model (LLM) 116. The method further includes continuously monitoring the user input for updates using the knowledge ingestion agent 108 and automatically extract new context upon determining the updates in the user input 202.

The order in which the flowchart 300 is described is not intended to be construed as a limitation, and any number of the described method blocks can be combined in any order to implement the flowchart 300 or alternate methods. Additionally, individual blocks may be deleted from the flowchart 300 without departing from the spirit and scope of the subject matter described herein. Furthermore, the method can be implemented in any suitable hardware, software, firmware, or combination thereof.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the scope being indicated by the following claims.

What is claimed is:

1. A system for dynamic content correction through adaptive auto-prompting, the system comprising:
one or more processors; and
a memory, operably connected to the one or more processors, wherein the one or more processors are configured to:
determine a context of a content by analysing user input using a knowledge ingestion agent;
generate one or more prompts based on the context using a prompt creation agent;
create an initial content based on the one or more prompts;
modify one or more subsequent prompts based on one or more parameters;
rank each of the one or more subsequent prompts using a prompt ranking and selection agent based on at least one of relevance, user feedback, and predefined criteria;
providing a selected set of the one or more subsequent prompts to user based on the rank of each of the one or more subsequent prompts; and
dynamically generate a refined content for the selected set of the one or more subsequent prompts based on the one or more parameters.

2. The system of claim 1, wherein the one or more parameters comprise at least one of user feedback to the one or more subsequent prompts or evaluating the one or more subsequent prompts using a pretrained large language model (LLM).

3. The system of claim 1, wherein the one or more processors are configured to update a knowledge base with the refined content using a knowledge creation agent, wherein the knowledge base is used in subsequent prompt generation and content correction.

4. The system of claim 1, wherein the knowledge ingestion agent is configured to continuously monitor the user input for updates and automatically extract new context upon determining the updates.

5. The system of claim 1, wherein the one or more processors are configured to analyze patterns in the user feedback received to refine the subsequent prompts to align with anticipated user preferences.

6. The system of claim 5, wherein the prompt ranking and selection agent is configured to select contextually appropriate prompts based on the user preferences and the context of the query.

7. The system of claim 1, wherein the one or more processors are configured to store the one or more prompts, the one or more subsequent prompts and associated user feedback in a prompt store.

8. A method for dynamic content correction through adaptive auto-prompting, the method comprising:
determining a context of a content by analysing user input using a knowledge ingestion agent;
generating one or more prompts based on the determined context using a prompt creation agent;
creating an initial content based on the one or more generated prompts;
modifying one or more subsequent prompts based on one or more parameters;
ranking each of the one or more subsequent prompts using a prompt ranking and selection agent based on at least one of relevance, user feedback, and predefined criteria;
providing a selected set of the one or more subsequent prompts to user based on the rank of each of the one or more subsequent prompts; and
dynamically generating a refined content for the selected set of the one or more subsequent prompts based on the one or more parameters.

9. The method of claim 8, wherein the one or more parameters comprise at least one of user feedback to the one or more subsequent prompts or evaluating the one or more subsequent prompts using a pretrained large language model (LLM).

10. The method of claim 8, further comprising:
continuously monitoring the user input for updates using the knowledge ingestion agent and automatically extract new context upon determining the updates in the user input.

11. The method of claim 8, further comprising:
updating a knowledge base with the refined content using a knowledge creation agent, wherein the knowledge base is used in subsequent prompt generation and content correction.

12. The method of claim 8, further comprising:
analyzing patterns in the user feedback received to refine the subsequent prompts to align with anticipated user preferences.

13. The method of claim 12, further comprising:
selecting, by the prompt ranking and selection agent, contextually appropriate prompts based on the user preferences and the context of the query.

14. The method of claim 1, further comprising:
storing the one or more prompts, the one or more subsequent prompts and associated user feedback in a prompt store.

15. A non-transitory computer-readable medium storing computer-executable instructions for dynamic content correction through adaptive auto-prompting, the computer-executable instructions configured for:
determining a context of a content by analysing user input using a knowledge ingestion agent;
generating one or more prompts based on the determined context using a prompt creation agent;
creating an initial content based on the one or more generated prompts;
modifying one or more subsequent prompts based on one or more parameters;
ranking each of the one or more subsequent prompts using a prompt ranking and selection agent based on at least one of relevance, user feedback, and predefined criteria;
providing a selected set of the one or more subsequent prompts to user based on the rank of each of the one or more subsequent prompts; and
dynamically generating a refined content for the selected set of the one or more subsequent prompts based on the one or more parameters.

16. The non-transitory computer-readable medium of claim 15, wherein the one or more parameters comprise at least one of user feedback to the one or more subsequent prompts or evaluating the one or more subsequent prompts using a pretrained large language model (LLM).

17. The non-transitory computer-readable medium of claim 15, wherein the computer-executable instructions are configured for:
updating a knowledge base with the refined content using a knowledge creation agent, wherein the knowledge base is used in subsequent prompt generation and content correction.

18. The non-transitory computer-readable medium of claim 15, wherein the computer-executable instructions are configured for:
continuously monitoring the user input for updates using the knowledge ingestion agent and automatically extract new context upon determining the updates in the user input.

19. The non-transitory computer-readable medium of claim 15, wherein the computer-executable instructions are configured for:
analyzing patterns in the user feedback received to refine the subsequent prompts to align with anticipated user preferences.

20. The non-transitory computer-readable medium of claim 19, wherein the computer-executable instructions are configured for:
selecting, by the prompt ranking and selection agent, contextually appropriate prompts based on the user preferences and the context of the query.
